(19) United States
(12) Patent Application Publication
(10) Pub. No.: US 2018/0043377 A1
(43) Pub. Date: Feb. 15, 2018

(54) SPLASH WATER OUTLET MECHANISM

(71) Applicant: XIAMEN SOLEX HIGH-TECH INDUSTRIES CO., LTD., Xiamen (CN)

(72) Inventors: Wencong XU, Xiamen (CN); Zhaoxing LAN, Xiamen (CN); Mingfu ZHANG, Xiamen (CN); Wenxing CHEN, Xiamen (CN)

(73) Assignee: XIAMEN SOLEX HIGH-TECH INDUSTRIES CO., LTD., Xiamen (CN)

(21) Appl. No.: 15/395,369

(22) Filed: Dec. 30, 2016

(30) Foreign Application Priority Data
Aug. 11, 2016 (CN) 201610656601.7

(51) Int. Cl. B05B 1/34; B05B 1/18

(52) U.S. Cl. CPC B05B 1/3426; B05B 1/185

(57) ABSTRACT

A water outlet mechanism, includes at least two diversion waterway sets connected to the water source and an outlet, each diversion waterway set has at least two diversion waterways and at least two water diversion passages; water from the at least two diversion waterways impact and converge and then enter the water diversion passages, the flowing direction of the at least two water diversion passages intersect, and water from the at least two water diversion passages impact and then spray out of the outlet. Water from at least two diversion waterways impacts and converges and then enters the water diversion passage, the water particles are refined and shaken; the direction of the at least two water diversion passages intersect, and water in the cavity of the inlet impact again to form wavy water type and then sprays out of the outlet.

### FIELD OF THE INVENTION

The present invention relates to a splash water outlet mechanism.

### BACKGROUND OF THE INVENTION

Existing outlet mechanism, as disclosed in American patent database with publishing number U.S. Pat. No. 3,563,462, comprises two first waterways, each waterway is disposed with a second waterways; the outlet water of the two first waterway converges to form a third waterway; water in the two second waterways and the third waterway converges and drains out of the outlet. A portion of water doesn't go through two impacts, the refining effect of water particles is bad, the water particles are still large. The existing outlet mechanism needs further improvement.

### SUMMARY OF THE INVENTION

The present invention is provided with a splash water outlet mechanism, which overcomes the disadvantages of the traditional technology.

The technical solution of the present invention is that:

A splash water outlet mechanism, comprising at least two diversion waterway sets (12) connected to the water source (10) and an outlet (14), each diversion waterway set (12) comprises at least two diversion waterways (16, 18), wherein further comprising at least two water diversion passages (20, 22); water of the at least two diversion waterways (16, 18) impact and converge to the water diversion passages (20, 22), the flowing direction of the at least two water diversion passages (20, 22) intersect, water impacts and sprays out of the outlet (14).

In another preferred embodiment, the outlet openings of the at least two diversion waterways (16, 18) face to each other.

In another preferred embodiment, it further comprises an inlet waterway (24) connected to the water source (10), each diversion waterway set (12) comprises at least a first diversion waterway (16) and a second diversion waterway (18), the inlet waterway (24) is connected to the second diversion waterways (18) of the diversion waterway sets (12), the inlet waterway (24) and the second diversion waterways (18) are arranged in L shape.

In another preferred embodiment, the first diversion waterway (16) of the diversion waterway sets (12) comprises a longitudinal portion connected to the water source (10) and a lateral portion connected to the longitudinal portion, the lateral portion is faced to and connected to the second diversion waterway (18).

In another preferred embodiment, the second diversion waterways (18) are arranged in a smooth curve.

In another preferred embodiment, the connecting portion of the inlet waterway (24) and the second diversion waterway (18) is smooth transition.

In another preferred embodiment, the diversion waterway sets (12) are corresponding to water diversion passages (20, 22) one by one; the entrance of the converge portion of the at least two diversion waterways (16, 18) faced to the water diversion passages (20, 22) is concaved.

In another preferred embodiment, two water diversion passages (20, 22) of the at least two water diversion passages (20, 22) are axially symmetrically arranged, the outlet opening of the two water diversion passages are faced to each other, the flowing direction of the outlet opening of the two water diversion passages intersect.

In another preferred embodiment, two water diversion passages (20, 22) are arranged smoothly, and the two diversion passages (20, 22) form a splayed structure with the openings faced upwardly.

In another preferred embodiment, it comprises a diverter shell (26) and a diverter (28), the diverter shell (26) is hollow throughout, the diverter (28) is fixedly assembled in the diverter shell (26), the diverter (28) is disposed with above mentioned outlet (14), the inlet waterway (24), the second diversion waterways (18), the lateral portions and the water diversion passages (20, 22); the entrance of the lateral portion is disposed at the outer wall of the diverter (28), a gap or notch is disposed between the inner wall of the diverter shell (26) and the outer wall of the diverter (28), the gap or the notch forms above mentioned longitudinal portion.

In another preferred embodiment, the portion of the diverter (28) faced to the inlet waterway (24) is concaved with a concave portion.

In another preferred embodiment, the diverter (28) comprises a main body portion (30) and a coupling portion (32), a first coupling surface of the main body portion (30) is concaved with above mentioned outlet (14), the inlet waterway (24), the second diversion waterway (18), the lateral portion and a groove portion (34) of the water diversion passages (20, 22), a second coupling surface of the coupling portion (32) is fixedly connected to the first coupling surface of the main body portion (30) in sealing way, the sealing connection makes the groove portion (34) form above mentioned outlet (14), the inlet waterway (24), the second diversion waterway (18), the lateral portion and the water diversion passages (20, 22).

In another preferred embodiment, the diverter (28) comprises a base (36) and an accessory portion (38),the base (36) is disposed with a first coupling surface, the lower portion of the first coupling surface is protruding with a protruding portion, the top surface of the protruding portion is concaved with a first groove, the first groove is connected to the bottom surface of the protruding portion, the lower portion of the first groove forms above mentioned outlet (14); the accessory portion (38) is disposed with a second coupling surface, the second coupling surface is concaved with a second groove; the accessory portion (38) is fixedly connected to the base (36), the accessory portion (38) is disposed above the protruding portion of the base (36), the second coupling surface of the accessory portion (38) is coupled to the first coupling surface of the base (36), and the second groove forms above mentioned inlet waterway (24) and the second diversion waterway (18), the accessory portion (38) and the protruding portion are arranged with space to form above mentioned lateral portion, the accessory portion (38) and the groove wall of the first groove are arranged with space to form above mentioned water diversion passages (20, 22).

Compared to the traditional technology, the technical solution of the present invention has following advantages:

Water from at least two diversion waterways impact and converge and then enter the water diversion passage, the water particles are refined and shaken, the refining effect is well; the direction of the at least two water diversion passages intersect, and water in the cavity of the inlet impact again to form wavy water type and then sprays out of the outlet, forming oscillating splash water. By controlling the intersecting direction of the flowing, the device can form intersecting water beams at the intersection surface, and enlarge the width of the intersecting water beams.

The at least two diversion waterways have the outlet opening face to face, the water particles are refined better.

The entrance of the converge portion of the at least two diversion waterways faced to the water diversion passages is concaved, swirl water forms in the concave portion, thus generating turbulent and oscillating flowing.

The two water diversion passages are arranged smoothly, and the two water diversion passages form a splayed structure with the opening faced upwardly, thus increasing the swirl effect and the oscillating effect, thus forming oscillating splash water.

### BRIEF DESCRIPTION OF THE DRAWINGS

The present invention will be further described with the drawings and the embodiments.

FIG. 1 illustrates a sectional diagram of a splash water outlet mechanism of a first embodiment.

FIG. 2 illustrates an exploded and schematic diagram of the splash water outlet mechanism of the first embodiment.

FIG. 3 illustrates a front view of a main body portion of the first embodiment.

FIG. 4 illustrates a left view of the main body portion of the first embodiment.

FIG. 5 illustrates a top view of the main body portion of the first embodiment.

FIG. 6 illustrates a back view of a coupling portion of the first embodiment.

FIG. 7 illustrates a right view of the coupling portion of the first embodiment.

FIG. 8 illustrates a top view of the coupling portion of the first embodiment.

FIG. 9 illustrates a schematic diagram of the splash water outlet mechanism applied in a shower head.

FIG. 10 illustrates a sectional diagram of the splash water outlet mechanism applied in the shower head.

FIG. 11 illustrates an exploded and schematic diagram of the splash water outlet mechanism applied in the shower head.

FIG. 12 illustrates a back view of an accessory portion of a second embodiment.

FIG. 13 illustrates a right view of the accessory portion of the second embodiment.

FIG. 14 illustrates a top view of the accessory portion of the second embodiment.

FIG. 15 illustrates a front view of the base of the second portion with partial section.

FIG. 16 illustrates a sectional diagram of the base of the second embodiment.

FIG. 17 illustrates a partial top view of the base of the second embodiment.

### DETAILED DESCRIPTION OF THE EMBODIMENTS

### Embodiment 1

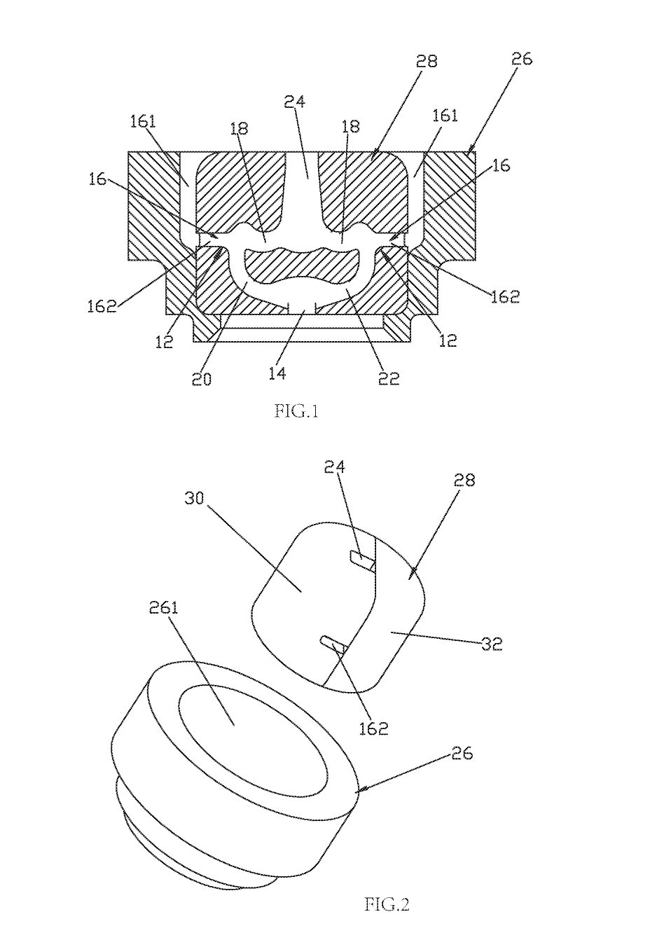

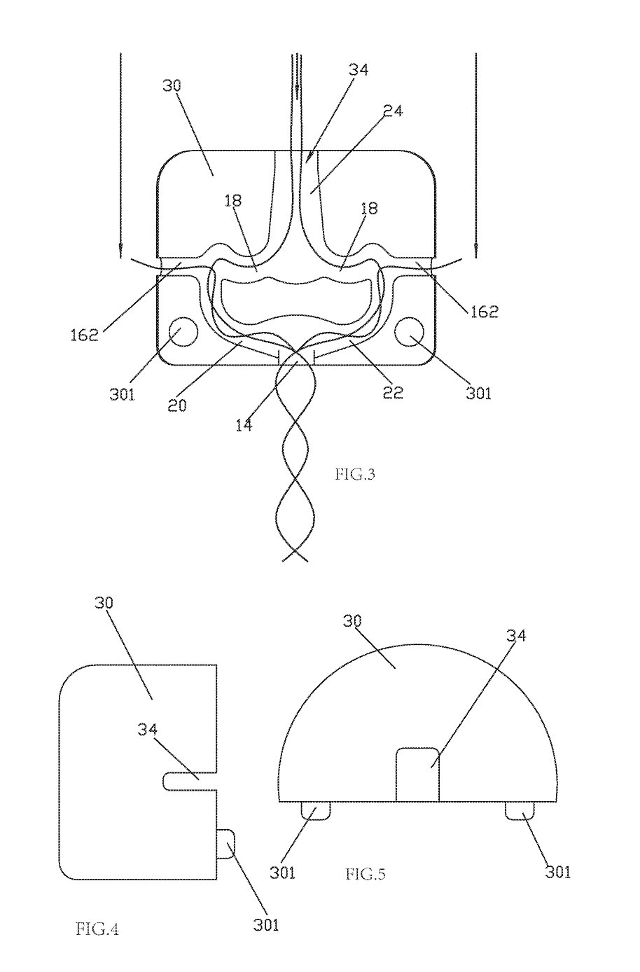

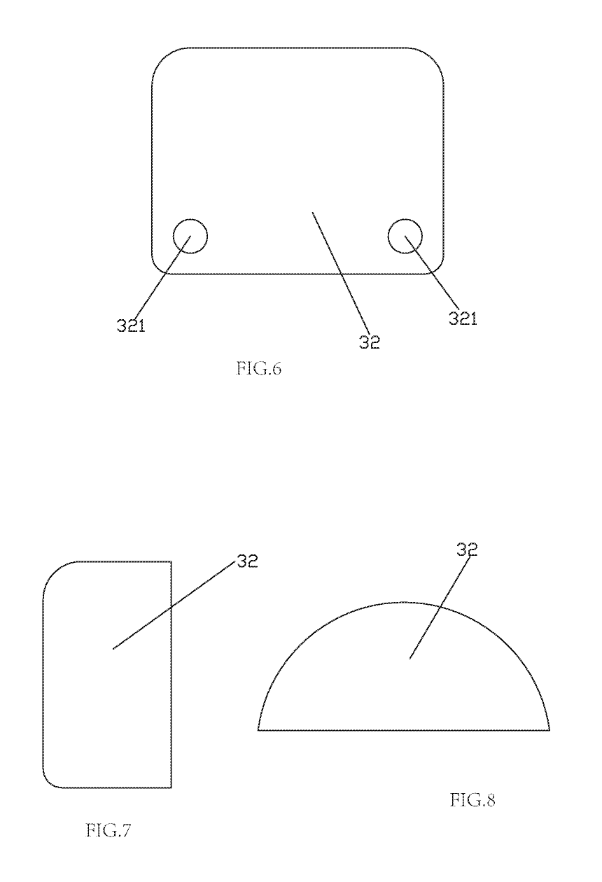

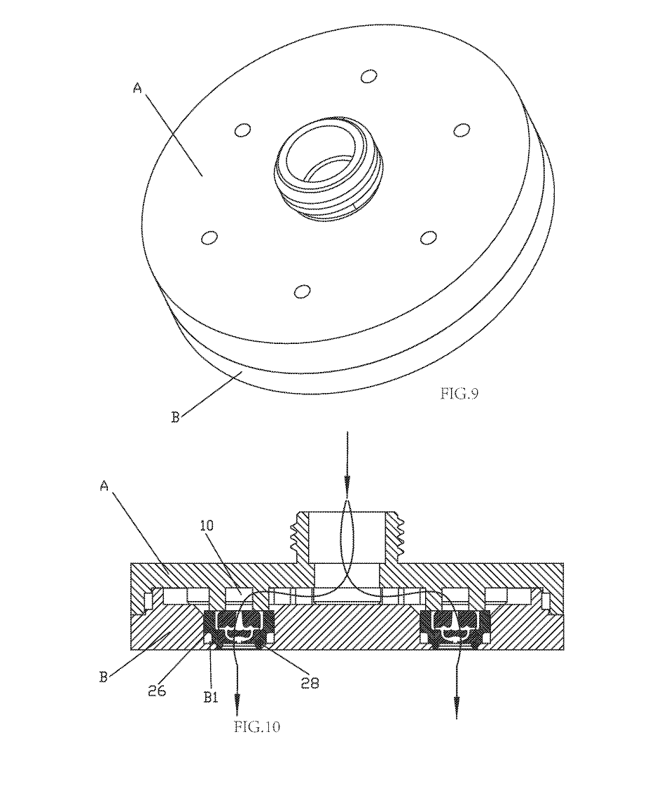

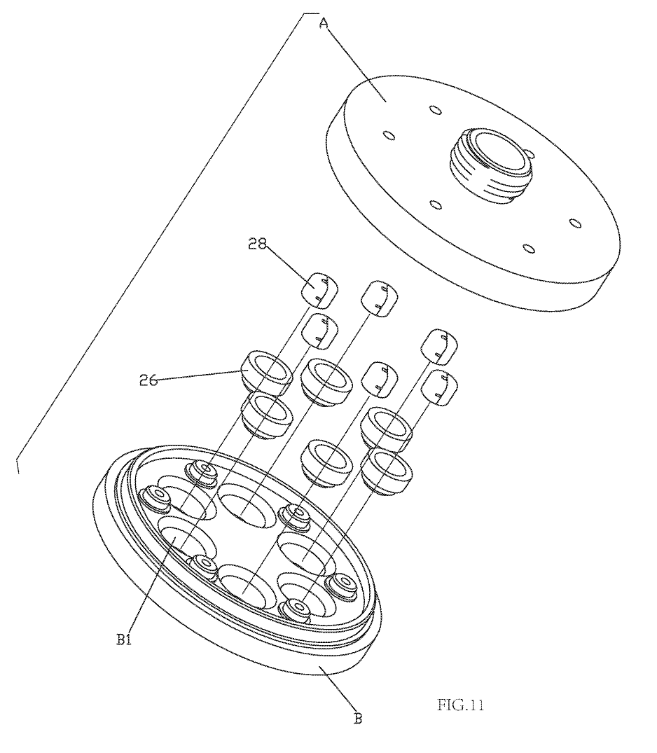

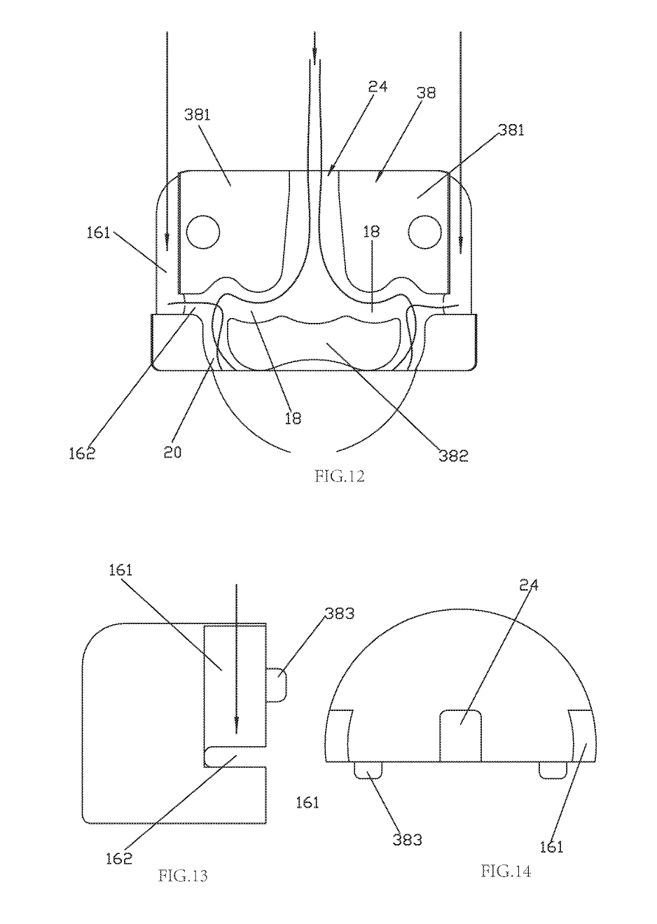

Please referring to FIGS. 1-8, a splash water outlet mechanism comprises two diversion waterway sets 12 connected to the water source 10, an outlet 14 and two water diversion passages 20, 22; each diversion waterway set 12 comprises two diversion waterways, one of them is first diversion waterway 16, the other is second diversion waterway 18, the two diversion waterway sets 12 are corresponding to the two water diversion passages 20, 22 one by one; the exits of the two diversion waterways 16, 18 are faced to each other, water of the two diversion waterways 16, 18 impact and converge to the water diversion passages 20, 22, the flowing direction of the two water diversion passages 20, 22 intersect, water impacts and sprays out of the outlet 14. The water flowing area of the water diversion passage is smaller than the sum of flowing area of the first diversion waterway 16 and the second diversion waterway 18, or smaller than the flowing area of the second diversion waterway 18.

In detailed, the outlet mechanism further comprises an inlet waterway 24 connected to the water source 10, the inlet waterway 24 is connected to the second diversion waterways 18 of the diversion waterway sets 12, the inlet waterway 24 and the second diversion waterways 18 are arranged in L shape, making water from the inlet waterway 24 firstly impact the mechanism and then turn to the second diversion waterways 18, water impacts to refine the particles. The first diversion waterway 16 comprises a longitudinal portion 161 connected to the water source 10 and a lateral portion 162 connected to the longitudinal portion 161, the second diversion waterways 18 are arranged laterally, making the lateral portion 162 and the second diversion waterways 18 connected face to face, water flowing from the longitudinal portion 161 to the lateral portion 162 needs to change its direction, during changing the direction, collision happens to refine the water particles. The second diversion waterways are arranged in a smooth curve laterally.

In detailed, the connecting portion of the inlet waterway 24 and the second diversion waterway 18 is smooth transition for example in arc shaped, the portion of the diverter 28 faced to the inlet waterway 24 is disposed with a concave portion, making water flowing from the inlet waterway to the second diversion waterway rotate in swirl shape, forming turbulent flowing; the second diversion waterways 18 are arranged in a smooth curve laterally, further improving the turbulent flowing and enhancing the swirl; the entrance of the converge portion of the two diversion waterways 16, 18 faced to the water diversion passages 20, 22 is concaved for example an arc groove, the second diversion waterways 18 are arranged in a smooth curve laterally, further improving the turbulent flowing and enhancing the swirl. Above mentioned smooth transition of the inlet waterway and the second diversion waterway, the second diversion waterway and the concaved structure at the entrance of the of the converge portion of the two diversion waterways 16, 18 faced to the water diversion passages 20, 22 form a reverse S shape. Water of the first diversion waterway and the second diversion waterway impacts and speeds up to enter the water diversion passage.

The two water diversion passages 20, 22 are axially symmetrically arranged, the outlet opening of the two water diversion passages 20, 22 are faced to each other, the flowing direction of the outlet of the water diversion passages 20, 22 intersect, therein, the two water diversion passages 20, 22 are arranged smoothly, for example, in an arc, and the two water diversion passages 20, 22 form a splayed structure with the opening faced upwardly. The smooth arrangement increases the swirl effect of water after the impacting, thus increasing the turbulent flowing.

In detailed, the splash water outlet mechanism comprises a diverter shell 26 and a diverter 28. The diverter shell 26 is hollow with a hollow hole penetrating through the diverter shell 26, the diverter 28 is relatively fixedly assembled in the diverter shell 26, the relative fixed connection is configured for example: the hollow hole 261 of the diverter shell 26 is disposed with a step hole with a step surface face upwardly, the diverter 28 is positioned on the step surface for positioning, the outlet mechanism is assembled in the main body of the shower head and is fixed in the main body by the main body structure. The diverter 28 is disposed with above mentioned outlet 14, the inlet waterway 24, the second diversion waterway 18, the lateral portion 162 and the water diversion passages 20, 22, the inlet of the lateral portion 162 is disposed in the outer wall of the diverter 28, a gap or notch is defined between the inner wall of the diverter shell 26 and the outer wall of the diverter 28, the gap or notch forms above mentioned longitudinal portion 161; the outlet is connected to the lower portion of the hollow hole, the diameter of the lower portion of the hollow hole is greatly larger than the diameter of the outlet. The splash water outlet mechanism is simple and compact, the manufacturing costs low, the molding costs low, the assembly is convenient and fast.

In detailed, the diverter 28 comprises a main body portion 30 and a coupling portion 32, the first coupling surface of the main body portion 30 is concaved with groove portions 34 corresponding to above mentioned outlet 14, the inlet waterway 24, the second diversion waterway 18, the lateral portion 162 and the water diversion passages 20, 22, the second coupling surface of the coupling portion 32 and the first coupling surface of the main body portion 30 are fixedly connected to each other face to face in sealing way, the fixed connection is realized by the diverter assembled into the diverter shell, the sealing connection makes the concave portions 34 form above mentioned outlet 14, the inlet waterway 24, the second diversion waterway 18, the lateral portion 162 and the water diversion passages 20, 22. The splash water outlet mechanism is simple and compact, the manufacturing costs low, the molding costs low, the assembly is convenient and fast.

In this embodiment, the portion of the main body portion 30 faced to the inlet direction of the inlet waterway is arranged curve with opening face upwardly, the portion of the main body portion 30 faced to the outlet direction of the outlet is arranged curve with opening face downwardly, for example an arc groove, the turbulent flowing is increased, forming wavy water type spraying out of the outlet, and forming oscillating splash water.

To position the main body portion and the coupling portion conveniently, the main body portion is disposed with at least two protruding columns 301, the coupling portion is concaved with at least two insert holes 321, the protruding columns are inserted into the insert holes in coupling way.

Referring to FIGS. 9-11, the splash water outlet mechanism is applied in a shower head, the shower head comprises a top cover A and a bottom cover B, the bottom cover B is disposed with outlet nozzles B1 passing through the bottom cover up and down, the splash water outlet mechanism is fixedly assembled into the outlet nozzle B1, in detailed, the outlet nozzle B1 is disposed with step surface face upward, the splash water outlet mechanism is positioned on the step surface, the top cover A is fixedly connected to the bottom cover B in sealing way, the top cover A is contacted on the splash water outlet mechanism to fixedly assemble the top cover A, the bottom cover B and the splash water outlet mechanism, so as to fix the diverter shell 26 and the diverter 28. The inlet passage of the shower head is the water source 10 of the splash water outlet mechanism, for the shower head, the inlet passage is connected to a forestage water source, like a water pipe fixed to the wall.

### Embodiment 2

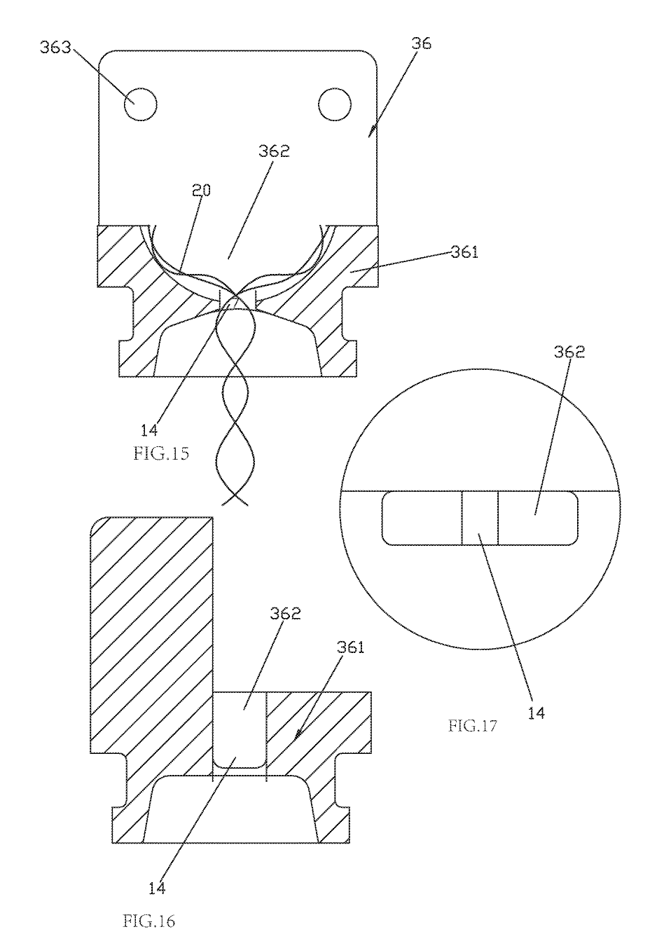

Referring to FIGS. 12-17, this embodiment differs from the first embodiment in that: the diverter 28 comprises a base 36 and an accessory portion 38.

The base 36 is disposed with a first coupling surface, the lower portion of the first coupling surface is protruding with a protruding portion 361, the top surface of which is concaved with a first groove 362; the first groove 362 is connected to the bottom surface of the protruding portion, the lower portion of the first groove forms above mentioned outlet 14.

The accessory portion 38 is disposed with a joining surface, which is convex with two first protrusions 381 and a second protrusion 382, the end face of the first protrusions and the second protrusion are the second coupling surface; the two first protrusions 381 are arranged symmetrically left and right with space, the space between the two first protrusions 381 defines the second groove corresponding to the inlet waterway, that is to say, the second groove is disposed in the second coupling surface. The two second protrusions 382 are disposed below the two first protrusions, the second protrusion 382 and the first protrusions are arranged with space, a third groove corresponding to the second diversion waterway is defined between the second protrusion 382 and the first protrusion, that is to say, the second coupling surface is disposed with the third groove. The joining surface has portions extending out of the left and right side of the first protrusion, the portions form the notch.

The accessory portion 38 is fixedly connected to the base 36, the accessory portion 38 is disposed above the protruding portion of the base 36, the second coupling surface of the accessory portion 38 is coupled to the first coupling surface of the base 36, and the second groove forms above mentioned inlet waterway 24, the third groove forms the second diversion waterway; the second protrusion is disposed in the first groove, between the joining surface and the second coupling surface, that is to say, the first notch forms the longitudinal portion; the lateral portion is formed between the first protrusion 381 and the protruding portion 361; the water diversion passages are formed between the joining surface and the second coupling surface, the groove wall of the first groove and the second protrusion.

The splash water outlet mechanism is simple and compact, the manufacturing costs low, the molding costs low, the assembly is convenient and fast. To position the base 36 and the accessory portion 38 conveniently, the accessory portion 38 is disposed with at least to protruding columns 383, the base 36 is concaved with at least two insert holes 363, the protruding columns are inserted to the insert holes in coupling way.

Although the present invention has been described with reference to the preferred embodiments thereof for carrying out the patent for invention, it is apparent to those skilled in the art that a variety of modifications and changes may be made without departing from the scope of the patent for invention which is intended to be defined by the appended claims.

1. A splash water outlet mechanism, comprising at least two diversion waterway sets (12) connected to the water source (10) and an outlet (14), each diversion waterway set (12) comprises at least two diversion waterways (16, 18), wherein further comprising at least two water diversion passages (20, 22); water from the at least two diversion waterways (16, 18) impact and converge and then enter the water diversion passages (20, 22), the flowing direction of the at least two water diversion passages (20, 22) intersect, and water from the at least two water diversion passages (20, 22) impact and then spray out of the outlet (14).

2. The splash water outlet mechanism according to claim 1, wherein the outlet openings of the at least two diversion waterways (16, 18) face to each other.

3. The splash water outlet mechanism according to claim 1, wherein further comprising an inlet waterway (24) connected to the water source (10), each diversion waterway set (12) comprises at least one first diversion waterway (16) and one second diversion waterway (18), the inlet waterway (24) is connected to the second diversion waterways (18) of the diversion waterway sets (12), the inlet waterway (24) and the second diversion waterways (18) are arranged in L shape.

4. The splash water outlet mechanism according to claim 3, wherein the first diversion waterway (16) of the diversion waterway sets (12) comprises a longitudinal portion connected to the water source (10) and a lateral portion connected to the longitudinal portion, the lateral portion is faced to and connected to the second diversion waterway (18).

5. The splash water outlet mechanism according to claim 3, wherein the second diversion waterways (18) are arranged in a smooth curve.

6. The splash water outlet mechanism according to claim 3, wherein the connecting portion of the inlet waterway (24) and the second diversion waterway (18) is smooth transition.

7. The splash water outlet mechanism according to claim 1, wherein the diversion waterway sets (12) are corresponding to water diversion passages (20, 22) one by one; the entrance of the converge portion of the at least two diversion waterways (16, 18) faced to the water diversion passages (20, 22) is concaved.

8. The splash water outlet mechanism according to claim 1, wherein the two water diversion passages (20, 22) of the at least two water diversion passages (20, 22) are axially symmetrically arranged, the outlet opening of the two water diversion passages are faced to each other, the outlet direction of the two water diversion passages intersect.

9. The splash water outlet mechanism according to claim 8, wherein the two water diversion passages (20, 22) are arranged smoothly, and the two diversion passages (20, 22) form a splayed structure with the opening faced upwardly.

10. The splash water outlet mechanism according to claim 4, wherein comprising a diverter shell (26) and a diverter (28), the diverter shell (26) is hollow throughout, the diverter (28) is fixedly assembled in the diverter shell (26), the diverter (28) is disposed with above mentioned outlet (14), the inlet waterway (24), the second diversion waterways (18), the lateral portions and the water diversion passages (20, 22); the entrance of the lateral portion is disposed at the outer wall of the diverter (28), a gap or a notch is disposed between the inner wall of the diverter shell (26) and the outer wall of the diverter (28), the gap or the notch forms above mentioned longitudinal portion.

11. The splash water outlet mechanism according to claim 10, wherein the portion of the diverter (28) faced to the inlet waterway (24) is concaved with a concave portion.

12. The splash water outlet mechanism according to claim 10. wherein the diverter (28) comprises a main body portion (30) and a coupling portion (32), a first coupling surface of the main body portion (30) is concaved with above mentioned outlet (14), the inlet waterway (24), the second diversion waterway (18), the lateral portion and a groove portion (34) of the water diversion passages (20, 22), a second coupling surface of the coupling portion (32) is fixedly connected to the first coupling surface of the main body portion (30) in sealing way, the sealing connection makes the groove portion (34) form above mentioned outlet (14), the inlet waterway (24), the second diversion waterway (18), the lateral portion and the water diversion passages (20, 22).

13. The splash water outlet mechanism according to claim 10, wherein the diverter (28) comprises a base (36) and an accessory portion (38),the base (36) is disposed with a first coupling surface, the lower portion of the first coupling surface is protruding with a protruding portion, the top surface of the protruding portion is concaved with a first groove, the first groove is connected to the bottom surface of the protruding portion, the lower portion of the first groove forms above mentioned outlet (14); the accessory portion (38) is disposed with a second coupling surface, the second coupling surface is concaved with a second groove; the accessory portion (38) is fixedly connected to the base (36), the accessory portion (38) is disposed above the protruding portion of the base (36), the second coupling surface of the accessory portion (38) is coupled to the first coupling surface of the base (36), and the second groove forms above mentioned inlet waterway (24) and the second diversion waterway (18), the accessory portion (38) and the protruding portion are arranged with space to form above mentioned lateral portion, the accessory portion (38) and the groove wall of the first groove are arranged with space to form above mentioned water diversion passages (20, 22).
